(19) United States
(12) Patent Application Publication
(10) Pub. No.: US 2009/0104592 A1
(43) Pub. Date: Apr. 23, 2009

(54) Lights Out Learning

(76) Inventor: Lewis Charles Miltenberger, Southlake, TX (US)

Correspondence Address: Stewart & Liu PLLC, P.O. Box 797277, Dallas, TX, 75379, US

(21) Appl. No.: 11/874,465

(22) Filed: Oct. 18, 2007

(51) Int. Cl. G09B 7/00

(52) U.S. Cl. 434/362

(57) ABSTRACT

A computer implemented method, apparatus, and computer program product for presenting interactive, educational content using a projector. In one embodiment, a set of learning modules associated with a subject matter is selected to form educational content. The educational content is displayed on a surface, by the projector. The educational content comprises a question. An answer for the question is received. In response to a determination that the answer for the question is a correct answer, a reward light show is displayed on the surface by the projector.

### BACKGROUND OF THE INVENTION

1. Field of the Invention

The present invention is related generally to an educational tool and in particular to a method and apparatus for a projector. More particularly, the present invention is directed to a computer implemented method, apparatus, and computer usable program code for using a projector to display interactive, personalized, educational lessons.

2. Description of the Related Art

Young children are frequently afraid of the dark and become ill at ease or frightened at the prospect of being left in a darkened room at or near bedtime. Currently, parents can leave a night light or a closet light turned on to provide light for the child. However, a night light only avoids the problem of the child's fear of being in a darkened room.

Projectors may be used to display images or movies on a surface in the darkened room. For example, star gazer type projectors display a star field on a wall or ceiling. Clock projectors can display a current time on a wall or ceiling. However, the images or movies displayed by a projector are pre-generated, static images that are not interactive. In other words, the projected images do not permit the child to provide input or responses to the projected images or change the images displayed based on the child's responses.

### SUMMARY OF THE INVENTION

The illustrative embodiments provide a computer implemented method, apparatus, and computer usable program code for presenting interactive, educational content using a projector. In one embodiment, a set of learning modules associated with a subject matter is selected to form education content. The educational content is displayed on a surface, by the projector. The educational content comprises a question. A user input providing an answer for the question is received. In response to a determination that the answer for the question is a correct answer, a reward light show is displayed on the surface by the projector.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a projector connected to a network of data processing systems in which illustrative embodiments may be implemented;

FIG. 2 is a block diagram of a projector in which illustrative embodiments may be implemented;

FIG. 3 is a block diagram illustrating a data flow through a projector in accordance with an illustrative embodiment;

FIG. 4 is a block diagram illustrating a projector for displaying educational content in accordance with an illustrative embodiment;

FIG. 5 is a block diagram illustrating a selection device selecting an answer choice in accordance with an illustrative embodiment;

FIG. 6 is a block diagram illustrating a reward lights show displayed in response to a correct answer selection in accordance with an illustrative embodiment;

FIG. 7 is a flowchart illustrating a process for displaying educational content by a projector in accordance with an illustrative embodiment;

FIG. 8 is a flowchart illustrating a process for generating customized educational content for display to a user in accordance with an illustrative embodiment; and

FIG. 9 is a flowchart illustrating a process for displaying a reward light show in accordance with an illustrative embodiment.

### DETAILED DESCRIPTION OF THE PREFERRED EMBODIMENT

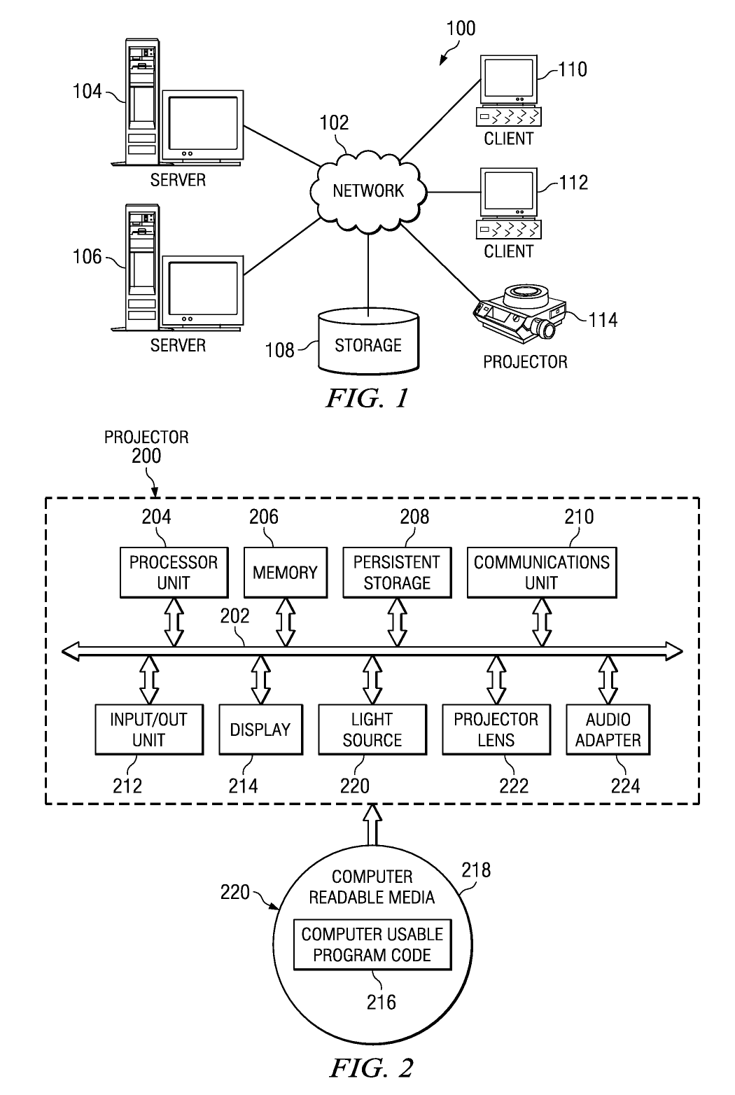

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a projector connected to a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

Network 102 may be implemented in any type of a network, including, without limitation, a wide area network (WAN), a local area network (LAN), an Ethernet, the Internet, and/or an intranet. In this example, network 102 is the Internet.

In the depicted example, server 104 and server 106 connect to network 102 along with storage unit 108. In addition, clients 110 and 112 connect to network 102. Clients 110 and 112 may be, for example, personal computers or network computers. In the depicted example, server 104 provides data, such as boot files, operating system images, and applications to clients 110 and 112. Clients 110 and 112 are clients to server 104 in this example. Network data processing system 100 may include additional servers, clients, and other devices not shown. Servers 104-106, clients 110-112, and/or storage 108 may include one or more learning modules available for download to projector 114.

Projector 114 is a projector for displaying educational content to a user, including, without limitation, numbers, letters, words, shapes, sentences, and/or pictures of objects. Projector 114 displays the educational content on a ceiling, one or more walls, a floor, and/or any other surface in a darkened environment, such as, but not limited to, a darkened bedroom. The educational content is projected in the form of a problem to be solved or an object to be identified.

Projector 114 includes a sensor or other detection device for detecting input from a user, such as an answer selection. For example, and without limitation, projector 114 may display a question, such as the following:

1+1=?

In one embodiment, projector 114 displays possible answers. In response, a user indicates an answer choice in the possible answers by pointing a laser pointer at a selected answer choice. In this example, the user presses a control button to select an answer choice, or otherwise manipulates an input device, such as an alphanumeric keypad, a control, a mouse or touch screen to select an answer choice. Projector 114 makes a determination as to whether the answer choice is correct. If the answer choice is correct, projector 114 displays a reward light show for the user.

Projector 114 may be implemented as any type of known or available projector for displaying images on a surface, such as a wall or ceiling. In this example, projector 114 is a projector for displaying images on a ceiling. In another embodiment, projector 114 may be mounted on a pivot or other rotational device for allowing projector 114 to optionally display images on a ceiling or be pivoted or rotated to display images on a wall or on the floor.

In this example, projector 114 is connected to network 102. Projector 114 utilizes network 102 to download learning modules from one or more remote devices, such as, but not limited to, server 104 and/or storage 108. In this example, projector 114 may optionally include a memory for storing learning modules, user profiles, and any other data needed by projector 114. However, projector 114 is not required to store this data locally on projector 114. Instead, projector 114 may optionally store and retrieve learning modules, user profiles, and/or any other needed data from a memory associated with a set of one or more remote computing devices connected to projector 114 via network 102.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

In another embodiment, projector 114 does not connect to a network. In this example, projector 114 includes a processor and a memory for storing learning modules, user profiles, and/or any other needed data. In other words, projector 114 does not require a network connection to present educational content to a user in accordance with this embodiment.

Referring now to FIG. 2, a block diagram of a projector is shown in which illustrative embodiments may be implemented. In this illustrative example, projector 200 includes communications fabric 202, which provides communications between processor unit 204, memory 206, persistent storage 208, communications unit 210, input/output (I/O) unit 212, and optionally display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multiprocessor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be, without limitation, a hard drive, a flash memory, a rewritable optical disk, a rewritable magnetic tape, a non-volatile random access memory (NVRAM), or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Communications unit 210 may include a network device for connecting to a network. A network device is any type of network access software known or available for allowing projector 200 to access a network. Communications unit 210 connects to a network connection, such as network 102 in FIG. 1. The network connection permits access to any type of network, such as a local area network (LAN), a wide area network (WAN), an Ethernet, or the Internet.

Input/output unit 212 allows for input and output of data with other devices that may be connected to projector 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as computer usable program code or computer readable program code that may be read and executed by a processor in processor unit 204.

The computer readable program code may be embodied on different physical or tangible computer readable media, such as memory 206 or persistent storage 208.

Computer usable program code 216 is located in a functional form on computer readable media 218 and may be loaded onto or transferred to projector 200. Computer usable program code 216 and computer readable media 218 form a computer program product 220 in these examples. In one example, computer readable media 218 may be, for example, an optical or magnetic disc that is inserted or placed into a drive or other device to that is part of persistent storage 208 for transfer onto a storage device such as a hard drive that is part of persistent storage 208. Computer readable media also may take the form of persistent storage 208, such as a hard drive or a flash memory that is connected to projector 200.

Alternatively, computer usable program code 216 may be transferred to projector 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmission containing the computer readable program code.

Projector 200 also includes light source 220 for generating light and projector lens 222 for projecting images onto a surface, such as, without limitation, a ceiling. Projector 200 may also optionally include audio adapter 224 for generating sounds. Audio adapter 224 is any known or available hardware and/or software for generating sounds and/or generating voice recognitions in a voice recognition system. In this example, projector 200 uses audio adapter 224 to generate audio content associated with the educational content displayed on the surface for the user. For example, and without limitation, projector 200 generates audio content reading words, numbers, and/or letters displayed by projector 200. Projector 200 may also generate audio content describing shapes, characters, symbols, or images displayed by projector 200. For example, if the visual image content displayed by projector 200 includes the word “cow,” the audio content includes an audio pronunciation of the word “cow” and/or the sounds that a cow makes, such as a “moo” sounds or a cow bell sound. In another example, if the following question is displayed as part of the visual image content:

2+3=?

The audio portion may include a voice speaking the words “two plus three equals” as part of the audio content. The audio content may also include the voice speaking or reading answer choices, such as “one, five, or six.” If a correct answer is selected, the reward light show may include reward sound content, such as the sound of fireworks, clapping, music, triumphant horns, a voice speaking words of praise, such as “great” or “terrific”, or any other sounds that offer praise or reinforcement for the user's efforts.

The different components illustrated for projector 200 are not meant to limit the architecture in which different embodiments may be implemented. The different illustrative embodiments may be implemented in a data processing system including components in addition to or in place of those illustrated for projector 200. [00411 Parents can use current projectors to display static, pre-generated, non-interactive images to a child in a darkened environment. However, current projectors do not display interactive educational content to a child that enables the child to dynamically select answers to questions displayed by the projector. Moreover, current projectors do not display different images to the child based on the child's responses to the projected images currently being displayed. In other words, current projectors are generally incapable of receiving input from a user and reacting to the input during the display of the projector by altering the sequence of images displayed, the type of images displayed, or the complexity or difficulty level of the content of the displayed images after the images have been prepared and loaded into the projector for display.

Therefore, the illustrative embodiments provide a computer implemented method, apparatus, and computer program product for presenting interactive, educational content using a projector. In one embodiment, a set of learning modules associated with a subject matter is selected to form education content. The educational content is displayed on a surface, by the projector. The surface may be a ceiling of a room, one or more walls of a room, a floor of a room, a ceiling and one or more walls of the room, the floor, ceiling, and walls of the room, a projector screen, or any other surface. The educational content comprises a question. An answer for the question is received from a user. In response to a determination that the answer for the question is a correct answer, a reward light show is displayed on the surface by the projector.

In one embodiment, a user can indicate a selected answer for the question by using a selection device. The selection device may be a wand-shaped device, a gun-shaped device, a glove, a remote control, a laser pointer, or any other device for indicating a selection of an answer. The projector detects a beam of light emitted by the selection device. The beam of light emitted by the selection device indicates the answer for the question selected by the user. In another example, the selection device emits a signal, such as an audio signal, a digital signal, an electronic signal, radio frequency identification (RFID) signal, a computer readable data stream over a wireless network connection, or any other type of signal capable of conveying information or an indication of an answer selection. In this example, the projector receives the signal from the selection device. The signal indicates the answer for the question selected by the user.

In another embodiment, the projector includes a voice recognition system. In this example, the user may verbally speak the answer and the voice recognition system is capable of using the verbally spoken answer as input indicating an answer selection. The voice recognition system may be implemented in any type of known or available voice recognition system integrated into the projector.

The educational content may be personalized for a particular user. In this example, the projector retrieves a user profile for the user. The user profile may include both a profile for the user and user settings selected by the user. The user's profile may include the user's name, age, birthday, favorite subjects, worst subjects, favorite animals, fictional characters, favorite sports, and/or any other personalized information for the user. The user settings may include a difficulty level for the educational content, a selected subject matter area, a number of questions to be presented to the user, an amount of time to answer each question, an amount of time to review educational content and answer questions, and/or any other settings for defining limitations on the educational content display.

The projector generates customized learning content by selecting the set of learning modules from a plurality of learning modules using the user profile. The projector generates the educational content using the selected set of learning modules. The educational content is customized for the particular user.

The projector may also generate a customized reward light show by retrieving the user profile for the user and selecting a set of learning modules from a plurality of learning modules using the user profile. The learning modules in this example include learning modules showing a reward laser light show for correct responses to questions. The projector generates the reward light show using the selected set of learning modules. In this manner, the reward light show is customized for the particular user.

In another embodiment, the set of learning modules is a first set of learning modules associated with a first difficulty level. In response to the user selecting a correct answer choice on a first attempt or within a predefined number of attempts, the projector selects a second set of learning modules associated with a second difficulty level that is a higher difficulty level than the first difficulty level to form additional educational content. The projector displays the additional educational content, which includes a second question that is more difficult than the first question. In this manner, the educational content presented to the user is graduated and becomes increasingly difficult as the user's level of skill, number of correct responses, response time, and/or past performance improves.

In another embodiment, if the user selects an incorrect answer to a question, the projector selects a second set of learning modules associated with a second difficulty level that is a lower difficulty level than the first difficulty level to form additional educational content. The projector displays the additional educational content, which includes a second question that is less difficult than the first question. In this manner, the personalized educational content becomes easier in response to a user's poor performance, slow response time, low number of correct responses, and/or failure to answer a question correctly within a predetermined amount of time.

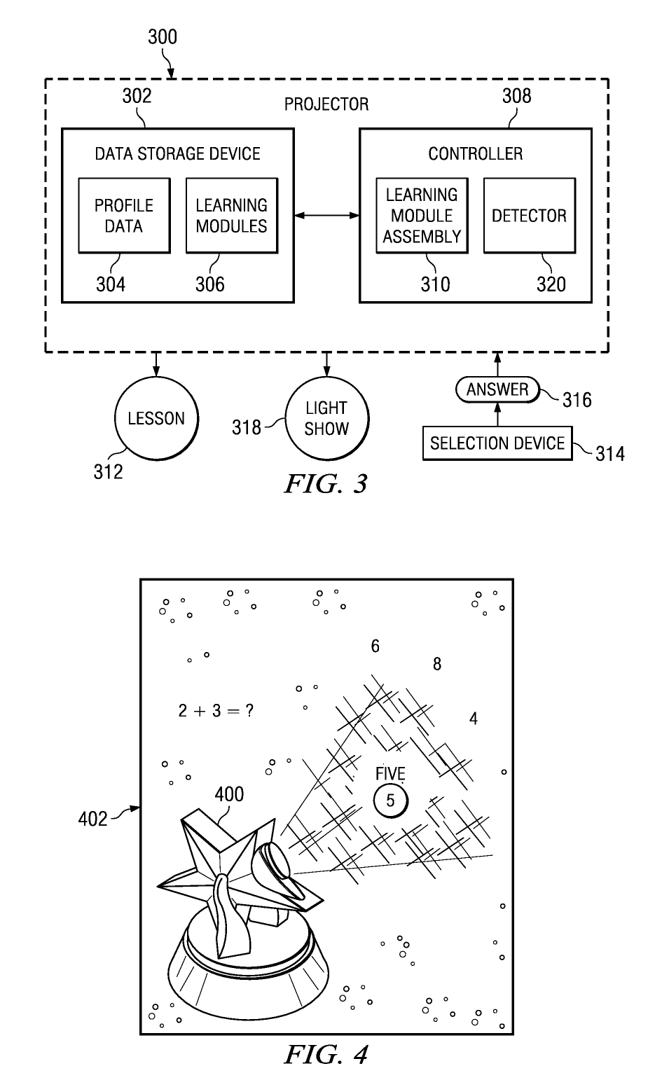

FIG. 3 is a block diagram illustrating a data flow through a projector in accordance with an illustrative embodiment. Projector 300 is a projector for projecting interactive, educational content, such as projector 114 in FIG. 1 or projector 200 in FIG. 2. In this example, projector 300 includes data storage device 302 for storing learning modules 306 and/or profile data 304. Data storage device 302 may be implemented in any type of known or available device for storing data, such as, without limitation, a hard drive, main memory, a flash memory, or any other type of data storage device. For example, data storage device 302 may be a data store, such as storage 108 in FIG. 1 or memory 206 in FIG. 2.

Learning modules 306 are a set of two or more self contained educational lessons, characters, or images that may be combined with one or more other learning modules in learning modules 306 to form a customized educational content for display to the user. Learning modules 306 can be quickly and dynamically assembled and disseminated to the customer in real-time as the user is viewing projected images and providing responses as input to questions imbedded within or associated with the projected images.

For example, if a child needs help with math and the child is interested in dinosaurs, a learning module containing a math question, such as 2+2=?, may be combined with a learning module that shows two dinosaurs walking towards two additional dinosaurs. These two learning modules may be combined to generate personalized educational content for presentation to the child. In this example, the personalized educational content may include a display of the numbers and symbols “2+2=” and an image of two dinosaurs on one side and two dinosaurs on a different side walking towards a central point. The numbers and dinosaur pictures may be presented simultaneously in a single image in which both the numbers “2+2” and the pictures of the dinosaurs are simultaneously visible. In another embodiment, the image of the numbers and the images of the dinosaurs may be shown as separate images displayed or projected in succession as a series of different images.

In this illustrative example, learning modules 306 are pre-generated learning modules. In other words, learning modules 306 are preexisting, self-contained, educational content associated with a particular subject matter that are created prior to receiving user input, user selections for a difficulty level of educational content, profile data 304 for the user, or any other data regarding a user and/or desired educational content for display. In this example, two or more learning modules in learning modules 306 are combined to dynamically generate customized educational content that is personalized for a particular user.

Although learning modules 306 are pre-generated, learning modules 306 may also include templates imbedded within learning modules 306 for adding personalized information, such as a child's name, siblings' names, friends' names, favorite character names, pet names, the child's age, birthday, or other personalized information to the customized educational content. For example, a user could provide user profile 304 indicating that the child is a 5 year old boy named Nathan that likes dinosaurs. In the example given above for the question “2+2=” in which an image of four dinosaurs are shown with the question, the educational content could also include a template for embedding the child's name in the question.

For example, the personalized educational content with the child's name added to the template could state the question as “Nathan sees two dinosaurs walking towards two more dinosaurs. How many dinosaurs does Nathan see? 2+2=?”. The child would then be prompted to select an answer from a set of answer choices. In another embodiment, projector 300 includes a voice recognition system. In this example, the child is prompted to verbally speak the answer. If the child selects the correct answer or speaks the correct answer, the child is rewarded with a light display.

Controller 308 is a software component for determining which learning modules in learning modules 306 should be combined or utilized to dynamically generate customized educational content for the user in real time. Controller 308 uses profile data 304 to identify one or more learning modules for the user. Profile data 304 is any data regarding a user that has been entered or provided as input to projector 300. Profile data 304 may include, but is not limited to, a user's name, address street, city, state, country, friends' names, pet's names, type of pets, favorite foods, favorite colors, favorite subjects, worst subjects, favorite animals, favorite fictional characters, favorite sports, hobbies, grade level in school, grades in school, weak educational subject areas, strong educational subject areas, siblings' names, likes and dislikes, favorite toys, and/or any other personalized information. Controller 308 uses profile data 304 provided by the user or a user's representative to select learning modules for presentation and/or to fill in data in templates to customize the educational content presented to the user.

Controller 308 also uses the user's performance to select learning modules and to fill in template information to customize educational content. In other words, the educational content is interactive and graduated. If a child is being presented with educational content at a first difficulty level and the child selects one or more incorrect answers or has a score that falls below a threshold level for performance, controller 308 will select learning modules in learning modules 306 that are at a second difficulty level that is easier or less complex than the first difficulty level.

In another embodiment, controller 308 also stores the user's current and past performance for each subject area and level of difficulty. Controller 308 recognizes if a child consistently struggles or performs poorly in particular subjects or at particular levels of difficulty. Thus, projector 300 dynamically changes educational content based on the user's interests, the user's current performance, and the user's past performance.

Learning module assembly 310 is a software component for combining the one or more modular marketing messages selected by controller 308 to form the customized educational content. Learning module assembly 310 combines two or more learning modules selected by controller 308 to create appropriate customized educational content for a user. In the example above for the child named Nathan, learning module assembly 310 adds the name “Nathan” to the template for the word problem, combines the selected learning module for the numbers and symbols math problem with the learning module showing the dinosaurs to generate the customized lesson that includes the word problem in which Nathan sees two dinosaurs joining two additional dinosaurs, the images showing the two dinosaurs joining the two additional dinosaurs, and the image of the numbers and symbols “2+2=” to form the personalized educational content for display by projector 300 on a ceiling or wall.

Lesson 312 is a personalized educational content associated with a subject matter area for display to the user. In this example, lesson 312 includes customized educational content that is a unique, one-to-one educational lesson for a specific child or adult user. Lesson 312 is generated by controller 308 using profile data 304, a child's current score or number of correct responses, a child's historical number of correct responses or scores to the same or similar subject matter content and the same or similar level of difficulty for the content, the current difficulty level of educational content being presented, and learning modules 306 to achieve this unique one-to-one marketing.

Lesson 312 may be generated using one or more learning modules in learning modules 306. For example, if two hundred learning modules are included in learning modules 306, controller 308 may select learning modules 5, 89, and 156 for a particular child. In this example, learning module assembly 310 combines modules 5, 89, and 156 to create personalized, interactive, educational content for a particular child. However, in this example, controller 308 may select different learning modules, such as learning modules 12, 54, 193 and 194, for a different child of the same age and grade level because the second child's interests and abilities are different than the interests and abilities of the first child.

For example, if the first child is a four year old boy that likes dinosaurs and does well in math but the second child is a four year old boy that likes robots and has more difficulty with mathematical concepts, the educational content for the second child may include images of robots to illustrate simpler math problems instead of images of dinosaurs. In this case, different personalized educational content is presented to each child rather than displaying the exact same lesson to both children based solely on the child's age and grade level.

Lesson 312 includes a question that requires the user to provide or select an answer, such as answer 316. A user may select an answer from a set of two or more answer choices by using a selection device, such as selection device 314.

Selection device 314 may be any type of device for providing input to projector 300 and/or indicating an answer or response. In this example, selection device 314 is a wand or pointing device that generates a light or laser beam for detection by projector 300. For example, if user points selection device 314 at an answer choice displayed by projector 300 and depresses a control to emit a light beam directed at the selected answer choice, projector 300 uses detector 320 to detect the answer indicated by the light beam.

Controller 308 then makes a determination as to whether answer 316 selected or indicated by the user matches a correct answer. If answer 316 matches the correct answer, projector 300 displays light show 318. In another embodiment, detector 320 is a receiver for receiving a signal emitted by selection device 314. In this embodiment, detector 314 is capable of detecting audio signals, radio wave signals, wireless network signals, or any other signals capable of transmitting an indication of a selected answer choice.

Selection device 314 may be implemented in any shape or form. For example, and without limitation, selection device 314 may be implemented in the shape of a magic wand, a fairy wand, or a gun or pistol with a trigger for activating selection device 314 to emit a beam of light or a signal to select an answer choice. In another example, selection device 314 may be implemented in the shape of a teddy bear or doll with a pointing device or light beam generating device embedded within a hand or arm of the bear that is activated to generate the beam of light or the signal by squeezing the bear or doll. Selection device 314 may also be implemented as a glove with sensors embedded in the glove for indicating a direction in which the user is pointing, a glove with a device embedded within a finger or other part of the glove for generating the light beam, or any other device for pointing or indicating an answer selection.

Selection device 314 may be a touch pad, personal digital assistant, or other hand held device having controls for indicating an answer selection. In another embodiment, selection device 314 is implemented in a voice recognition system associated with projector 300. The voice recognition system recognizes human voices and spoken words as input and provides human recognizable speech as output to the user. In this example, if the question “2+2=” is displayed, a user may simply speak the word “four” to form answer 316.

Light show 318 is a light display that is presented to a user as a reward for selecting a correct answer to a question associated with educational content displayed by projector 300. Light show 318 may include images, sounds, flashing lights, music, and/or any other audio or visual content for encouraging, praising, or rewarding the user for a correct response. In this example, light show 318 is a static, pre-generated light display.

However, light show 318 may also be customized or personalized for a particular user. For example, and without limitation, if a child likes fairies and princesses, light show 318 may be generated by controller 308 to include images of fairies flying through the air, clapping their hands, and saying “great” or “good job”. A customized reward light show may be generated in a similar manner as a customized lesson. In other words, controller 308 may select two or more light show modules to be combined by learning module assembly 310 for a particular user based on the user's interests. In addition, light show 318 may be generated using templates that permit personalized information associated with the user to be inserted into light show 318. For example, if the child that likes fairies in the example above is named Sally, light show 318 may include the images of the flying and clapping fairies with a display of the words “Good Work Sally” and/or audio content of the fairies saying “Great job Sally!”

Thus, in this illustrative example, projector 300 generates and displays lesson 312 for a user based on profile data 304 for the user and the user's current and/or past performance associated with a particular subject matter area. Lesson 312 includes a question. Projector 300 prompts the user to provide the answer. The user uses selection device 314 to select answer 316. If answer 316 is correct, projector 300 generates light show 318 for display to the user.

In this example, the user is a child. However, a person of any age may utilize projector 300 and selection device 314 for educational purposes in accordance with the illustrative embodiments.

In the example in FIG. 3, lesson 312 is a customized lesson that is generated for a particular user. However, the illustrative embodiments are not limited to displaying customized educational content. The illustrative embodiments may also be implemented to display pre-generated, static, non-personalized lessons and educational content for display to a user in accordance with the illustrative embodiments.

In this example, a single user reviews the customized educational content and selects answers to questions. However, in another example, two or more users may participate in reviewing questions and providing answers. In this example, the two or more users are located in proximity to projector 300 such that all the users can view the same display projected by projector 300 onto the ceiling and/or walls of a room. Each user may have a selection device, such as selection device 314, for choosing answers to questions presented by projector 300.

In this example, light show 318 is a stimulating reward light show that may include, but is not limited to, clapping, drums, horns, flashing lights, fireworks images, and other stimulating and/or encouraging images and sounds. In another embodiment, light show 318 is a soothing light show. In this example, light show 318 includes, but is not limited to, soft or relaxing music, the sound of ocean waves or softly falling rain, muted lights, softer colors, images of stars, and/or less stimulating images such that the user may be lulled into a relaxed or sleep-ready state. In this manner, the user may be assisted in falling asleep by answering questions presented by educational content and gradually being lulled into sleep.

Turning now to FIG. 4, a block diagram illustrating a projector displaying educational content is depicted in accordance with an illustrative embodiment. Projector 400 is a projector for displaying interactive, personalized, educational content to a user. Projector 400 may be a projector such as projector 114 in FIG. 1, projector 200 in FIG. 2, and/or projector 300 in FIG. 3.

Display 402 is an exemplary interactive, education display presented by projector 400. Display 402 is projected on a ceiling in a darkened environment, such as, without limitation, a bedroom with the lights turned off at night. In this example, a user, such as a child, lays on a bed looking up at the ceiling to view display 402. Display 402 includes a question in a given subject area. In this example, the question is a math question. However, the question may also be a reading question, a spelling question, a history question, a geography question, health question, a science question, a social studies question, a foreign language question, a literature question, or a question in any other subject.

The educational content included in display 402 includes a question and a plurality of answer choices. The user uses a selection device, such as selection device 314 in FIG. 3, to select an answer. When the correct answer is selected, display 402 is altered or modified to indicate a correct answer selection. In this example, the correct answer choice “5” is surrounded by a halo of light to indicate that answer choice “5” was the correct answer to the question presented in display 402.

In this example, display 402 is projected onto a ceiling. However, display 402 may also be projected on a wall, a floor, or any other surface in a darkened environment. Likewise, in this example, the user lays on a bed to view the display. However, the embodiments are not limited to this method for viewing display 402. A user may also lay on a floor, a cot, a couch, sit in a reclining chair or assume any other position which enables the user to view the educational content included in display 402.

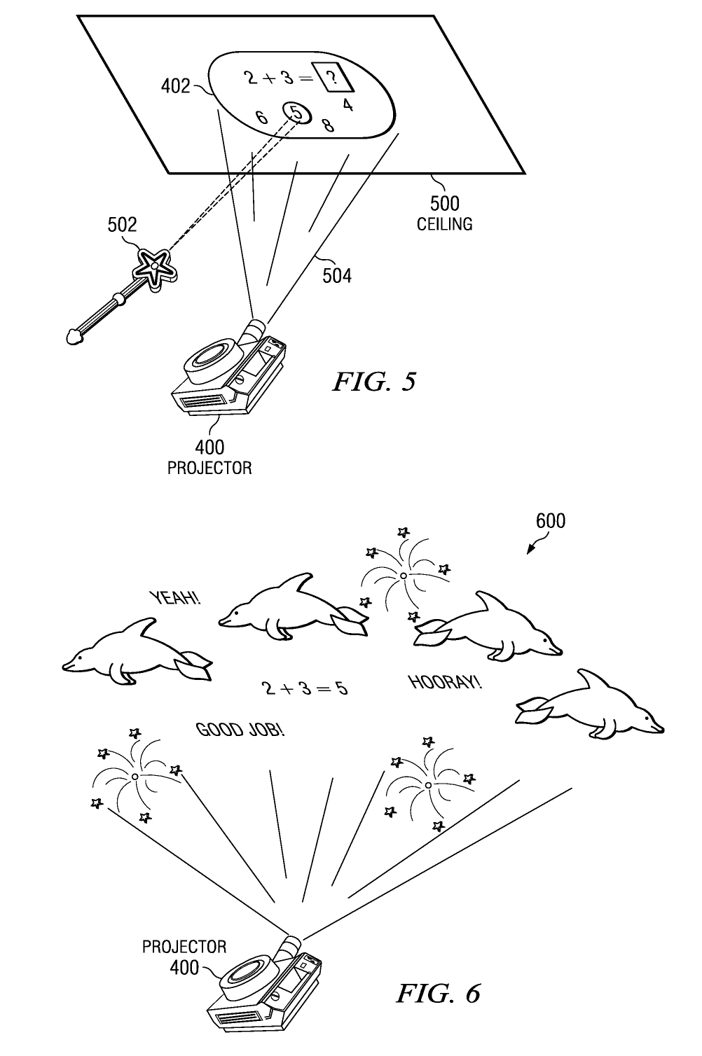

FIG. 5 is a block diagram illustrating a selection device for selecting an answer choice in accordance with an illustrative embodiment. In this example, projector 400 projects display 402 onto ceiling 500 for viewing by a user. In this example, display 402 includes possible answers that appear to float or travel across the same spectrum and can be selected by pointing selection device 502 at one of the answer choices.

Selection device 502 is an example of a selection device, such as selection device 314 in FIG. 3. In this example, selection device 502 is implemented in the shape of a magic wand or wand-shaped device. However, selection device 502 may also be implemented in the shape of a gun, a bear, a doll, a remote control, a glove, or any other device for indicating an answer selection. For example, if selection device 502 is a gun shaped device, the user points the gun at a selected answer choice and depresses a trigger to fire the gun. In response, selection device 502 emits beam of light 504 to indicate the selected answer choice.

The user points selection device 502 at an answer choice and selects a controller on selection device 502 to indicate an answer selection. The controller may be any type of button, switch, touch sensor, touch pad, heat sensor, pressure sensor, and/or any other known or available device for activating selection device 502 to select an answer choice.

In this example, when a user activates selection device 502 to select an answer choice, such as answer choice “5”, selection device 502 emits a light or laser beam which shines on or illuminates a selected answer choice provided in display 402. Projector 400 includes a sensor (not shown) capable of detecting the light or laser beam and identifying the answer choice indicated by the light or laser beam emitted by selection device 502. In this example, the sensor is a photosensitive sensor capable of detecting selected wavelengths of light emitted by selection device 502.

In another embodiment, selection device 502 includes a set of one or more controls. The user selects an answer choice by selecting a control on selection device. For example, if the answer choices are “6”, “5”, “8” and “4”, a user selects the answer “5” by selecting a control associated with the answer “5.” The control may be an alphanumeric keypad having a control designated as “5.” In another embodiment, the control may be a control for indicating selection of a first answer choice, a second answer choice, a third answer choice, and/or a fourth answer choice. In this example, the user selects the answer “5” by selecting the control associated with the 2^{nd} answer choice. Selection device 502 then transmits an indication of the selected answer choice to projector 400.

In the example above, selection device 502 may transmit a signal indicating a selected answer choice by transmitting a signal to projector 400 over a wireless network connection. The signal may be a data packet or machine-readable program code. In this example, projector 400 includes a network device (not shown) capable of connecting to a network access point and receiving data packets over the network connection from selection device 502. The data packet or message includes an indication of the answer choice selected by the user. In one example, the network is a wireless network. Projector 400 includes a network device for connecting to a wireless access point (WAP) to gain access to a wireless network, such as the Internet.

However, the embodiments are not limited to wireless network connections. In another embodiment, projector 400 includes a network device for connecting to a wire-full network connection for connecting to a network such as the Internet. Projector 400 may then download learning modules from remote servers and/or remote data storage devices, such as server 104 and storage 108 in FIG. 1.

In another embodiment, selection device 502 transmits a selected answer to projector 400 by transmitting a radio frequency signal or other sound indicating an answer selection. In this example, projector 400 includes an audio detection device (not shown) capable of detecting radio signals or other audio signals emitted by selection device 502.

Thus, in one embodiment, an interactive, educational device, such as projector 400, projects questions and answers onto ceiling 500 and/or walls of a darkened room. One or more users read the question or problem associated with the educational content of display 402. A user selects an answer choice from a plurality of answer choices provided in display 402. The user selects an answer by pointing a magic wand shaped selection device 502 or shooting a laser gun shaped selection device at a selected answer. A beam of light 504 is emitted from the gun or wand and projects on the selected answer, similar to a laser pointer used in presentations. A correct answer selection will result in a short laser show of lights on the ceiling and/or walls.

Referring now to FIG. 6, a block diagram illustrating a reward lights displayed in response to a correct answer selection is shown in accordance with an illustrative embodiment. Projector 400 displays reward light show 600 in response to a user selecting a correct answer choice. Reward light show 600 may include, without limitation, any combination of flashing lights, strobe lights, two or more different colored lights, fireworks, fictional characters, animals, cars, trucks, planes, stars, halos, candles, food, lightning, music, horns, verbal content, and/or any other images, sounds, symbols, voices, or animation that may be pleasing to a user and/or provide positive feedback for the user.

Voices and verbal content may include human recognizable speech, such as, but not limited to, the words “good job,” “well done,” “terrific,” “hooray,” or any other words of praise and/or encouragement. Reward light show 600 may include images of real or fictional humans and/or animals, such as, without limitation, dolphins, fairies, horses, ponies, unicorns, dogs, cats, eagles, mice, or any other real or fictional animal or human. The images included in reward light show 600 may be stationary or animated. In other words, if reward light 600 show includes images of robots, the robots may be still images of robots or the images may be animated images showing the robots clapping, cheering, transforming into different shapes, or flying. Reward light show 600 may also include animated images of fireworks exploding or any other animated images.

Reward light show 600 may also be personalized for the user. In this embodiment, when a correct answer is selected, reward light show 600 includes images of the child's name and/or audio content praising the user by name. For example, if a user's profile indicates the user's name is Lew, reward light show 600 may include audio content saying “Great job, Lew!”

In one embodiment, the shorter the response time for selecting a correct answer, the better reward light show 600 will be. In other words, if a correct answer is selected within a first predetermined period of time or if a correct answer is selected in an amount of time that is less than a first threshold amount of time, a first reward laser light show will be presented. If the correct answer is selected within a second predetermined period of time or if the correct answer is selected in an amount of time that is greater than the first threshold amount of time but less than a second threshold amount of time, a second reward laser light show will be presented. The first laser light show lasts longer than the second laser light show. In another embodiment, the first laser light show includes more images, more sounds, more animation, and/or more stimulating content than the second laser light show. Thus, the more quickly the user selects an answer and the shorter the response time, the better or more exciting the light show will be.

In another embodiment, if a first question is a higher difficulty level than a second question, the first reward light show is displayed in response to the user selecting a correct answer to the first question. In response to the user selecting a correct answer to the second question, the second reward light show is displayed. In this example, the more difficult the question, the better, and/or more exciting reward light show 600 will be and/or the longer reward light show 600 will last.

In another example, if a user selects a correct answer on a first attempt, the first reward light show is displayed. If the user selects an incorrect answer on the first attempt but selects the correct answer on the second attempt, the second reward light show is displayed. In this manner, reward light show 600 may be customized for a user based on the user's profile, user settings, difficulty level of the question answered, number of attempts to answer the question correctly, and/or the response time taken to select the correct answer.

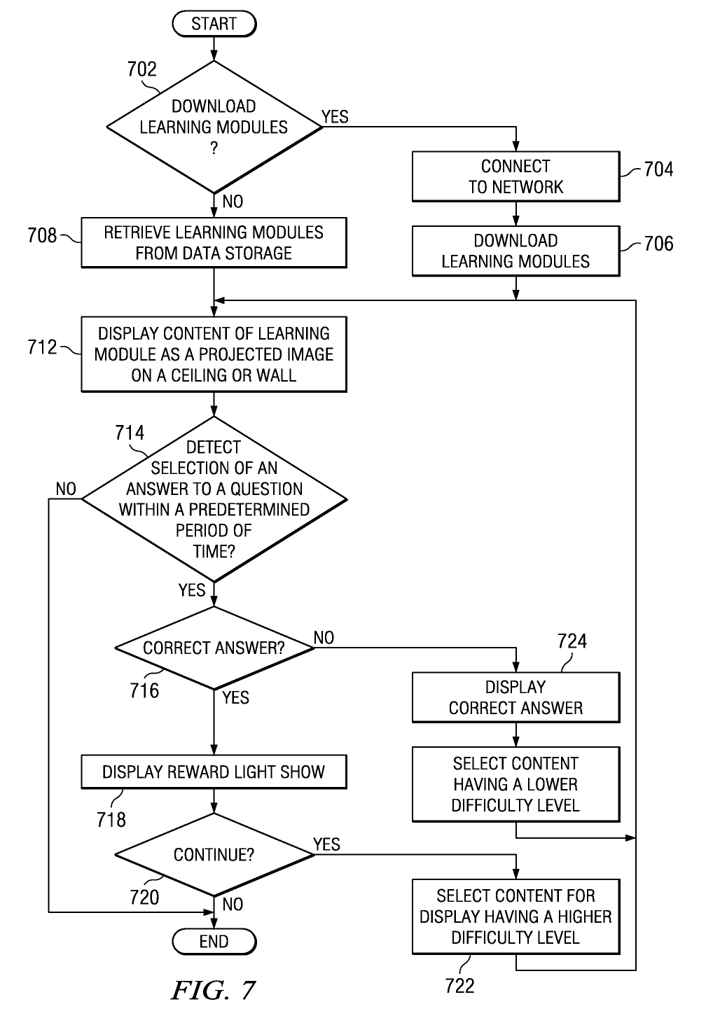

FIG. 7 is a flowchart illustrating a process for displaying educational content by a projector in accordance with an illustrative embodiment. The process in FIG. 7 may be implemented by a projector for projecting interactive educational content, such as projector 300 in FIG. 3.

The process begins by making a determination as to whether to download learning modules (step 702). If learning modules are to be downloaded, the process connects to a network (step 704) and downloads a set of two or more learning modules (step 706). Returning to step 702, if learning modules are not downloaded, the process retrieves a set of learning modules from data storage associated with the projector (step 708). After retrieving the set of learning modules at step 708 or downloading the set of learning modules at step 706, the process displays the content of one or more learning modules as a projected image on a ceiling, wall, or other surface for viewing by a user (step 712).

The process then makes a determination as to whether selection of an answer choice associated with a question is detected within a predetermined period of time (step 714). The predetermined period of time may be a user defined amount of time or a pre-generated default amount of time. If the predetermined amount of time expires without detection of an answer choice, the process assumes the user has fallen asleep, stopped viewing the projected image and associated education content, and/or has otherwise failed to answer a question associated with the educational content. The process terminates thereafter. In another embodiment, the correct answer to the question may be displayed rather than terminating the process and the user may be queried as to whether the user would like to continue or stop. If a response is not received within a predetermined period of time, the process terminates.

Returning to step 714, if selection of an answer to the question is detected within the predetermined period of time, the process makes a determination as to whether the correct answer was selected (step 716). If the correct answer was selected, a reward light show, such as reward light show 600 in FIG. 6, is displayed (step 718). The process then makes a determination as to whether to continue projecting interactive, educational content to the user (step 720). If a determination is made to continue displaying educational content, the process selects new content for display having a higher difficulty level (step 722). The process then iteratively executes steps 712-722 until a determination is made to not continue displaying interactive, educational content to the user at step 720 with the process terminating thereafter.

In one embodiment, rather than selecting content having a higher difficulty level at step 722, content is selected that is at the same difficulty level as the previously displayed educational content.

Returning now to step 716, if the user does not select the correct answer, the process displays the correct answer (step 724) and selects new educational content having a lower difficulty level (step 726). The process then iteratively continues to execute steps 712-726 until a determination is made at step 720 to discontinue projecting educational content to the user with the process terminating thereafter.

In this example, the educational content selected at step 722 and step 726 is educational content in the same subject area as the educational content displayed at step 712. For example, if the educational content at step 712 is a geography question related to states and capitals, the educational content selected at steps 722 and/or 726 will also be geography related educational content. However, in another embodiment, educational content selected at steps 712, 722, and 726 are not limited to a single subject matter or subject area. For example, a first question may be a geography question, such as, but not limited to, a question asking the user, “What is the capital of Texas?” The next question selected at step 722 may be a biological sciences question, such as, without limitation, a question asking the user “Is a bird a warm blooded animal?” The educational content selected at step 726 may be a math question. In this manner, a user may be presented with questions randomly selected from a plurality of different subject areas rather than being presented with questions from only a single subject area.

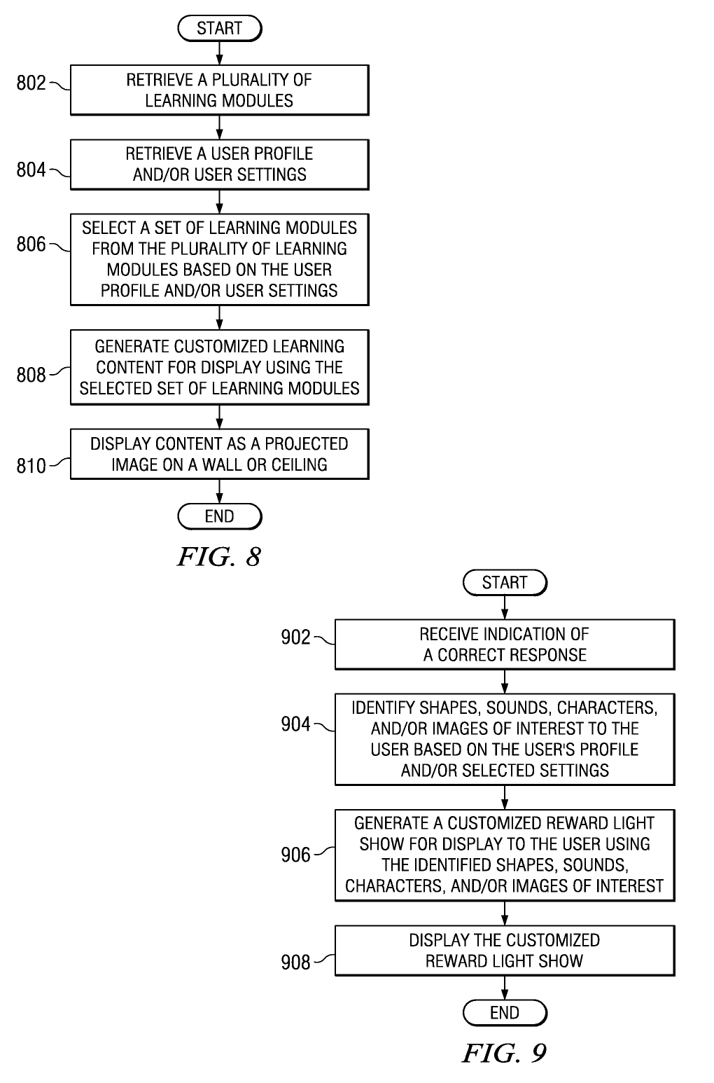

FIG. 8 is a flowchart illustrating a process for generating customized educational content for display to a user in accordance with an illustrative embodiment. The process in FIG. 8 is a more detailed description of step 712 in FIG. 7. The process in FIG. 8 may be implemented by a projector for projecting interactive educational content, such as projector 300 in FIG. 3.

The process begins by retrieving a plurality of learning modules (step 802). The process retrieves a user profile and/or user setting indicating a user's preferences and/or personal information associated with the user (step 804). The process selects a set of one or more learning modules from the plurality of learning modules based on the user profile and/or user settings (step 806). The process generates customized learning content for display to the user using the selected set of learning modules (step 808). In one embodiment, two or more selected modules are combined to form the customized learning content. Finally, the process displays the customized learning content as a projected image on a wall, ceiling, or other surface (step 810) with the process terminating thereafter.

In this example, the educational content includes both visual or graphical images and sound. In another example, the educational content only includes visual or graphical images without sound.

Turning now to FIG. 9, a flowchart illustrating a process for displaying a reward light show is depicted in accordance with an illustrative embodiment. The process in FIG. 9 is a more detailed description of step 718 in FIG. 7. The process in FIG. 9 may be implemented by a projector for projecting interactive educational content, such as projector 300 in FIG. 3.

The process begins by receiving an indication of a correct response or selection of a correct answer choice to a question associated with the displayed interactive, educational content (step 902). The process identifies shapes, sounds, characters, and/or images of interest to the user based on the user's profile and/or selected settings (step 904). The process generates a customized reward light show for display to the user using the identified shapes, sounds, characters, and/or images of interest to the user (step 906). For example, if the user's profile indicates the user likes space ships, the process generates a reward light show that includes one or more images of at least one space ship. The process then displays the customized reward light show (step 908) with the process terminating thereafter.

In this example, the reward light show includes both visual or graphical images and sound. In another example, the reward light show only includes visual or graphical images without sound. In another example, the reward light show includes only sound without any visual or graphical images.

Thus, the illustrative embodiments provide a computer implemented method, apparatus, and computer program product for presenting interactive, educational content using a projector. In one embodiment, a set of learning modules associated with a subject matter is selected to form education content. The educational content is displayed on a surface, by the projector. The educational content comprises a question. An answer for the question is received from a user. In response to a determination that the answer for the question is a correct answer, a reward light show is displayed on the surface by the projector.

The illustrative embodiments help parents solve problems encountered with children that are afraid of the dark. The process provides an educational based entertainment device that offers an opportunity for pre-school and elementary aged children to find excitement and pleasure in a darkened environment, which may occur at or near bedtime. In addition, the process provides an educational experience for children and rewards children with unique and exciting laser light shows on the ceiling and walls of their room when they select correct answers to questions.

In other words, the process may be used to create a desirable atmosphere where children want to go even though they may have historically been hesitant or fearful of spending time in the dark. In addition, the rewards of the laser light show or other stimulation may be used to make learning early concepts fun and entertaining for children. The educational levels or difficulty level of the educational content can be increased in a graduated manner. Children are able to learn at their individual pace. In one embodiment, children that are able to solve problems of increased difficulty and/or children that are able to correctly answer questions for a given difficulty level on a first attempt will receive more stimulation and/or a better reward light show. In other words, the better a child's performance, the more dramatic or rich the reward light show may be made to reward the child in accordance with their performance.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the steps may occur out of the order noted in the figures. For example, two steps shown in succession may, in fact, be executed substantially concurrently, or the steps may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk, millipede storage technology, Magneto-resistive random access memory (MRAM), or phase-change memory, also known as PCM, PRAM, Ovonic Unified Memory, and Chalcogenide RAM (C-RAM). Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for presenting interactive, educational content using a projector, the computer implemented method comprising:
selecting a set of learning modules associated with a subject matter to form education content;
displaying the educational content on a surface, by the projector, wherein the educational content comprises a question;
receiving a user input providing an answer for the question; and
responsive to a determination that the answer for the question is a correct answer, displaying a reward light show on the surface, by the projector.

2. The computer implemented method of claim 1 further comprising:
indicating the answer for the question from which the user input is generated, using a selection device.

3. The computer implemented method of claim 1 wherein receiving the answer for the question further comprises:
detecting a beam of light emitted by a selection device, wherein the beam of light emitted by the selection device indicates the answer selected by the user.

4. The computer implemented method of claim 1 wherein receiving the answer for the question further comprises:
receiving a signal from a selection device, wherein the signal indicates the answer for the question selected by the user.

5. The computer implemented method of claim 1 wherein the surface is a ceiling of a room.

6. The computer implemented method of claim 1 further comprising:
retrieving a user profile for a particular user;
selecting the set of learning modules from a plurality of learning modules using the user profile; and
generating the educational content using the selected set of learning modules, wherein the educational content is customized for the particular user.

7. The computer implemented method of claim 1 further comprising:
retrieving a user profile for a user;
selecting a set of learning modules from a plurality of learning modules using the user profile; and
generating the reward light show using the selected set of learning modules, wherein the reward light show is customized for the user.

8. The computer implemented method of claim 1 wherein the set of learning modules is a first set of learning modules associated with a first difficulty level and further comprising:
selecting a second set of learning modules associated with a second difficulty level that is a higher difficulty level than the first difficulty level to form additional educational content; and
displaying the additional educational content, by the projector, wherein the additional educational content comprises a second question that is more difficult than the first question.

9. The computer implemented method of claim 1 wherein the set of learning modules is a first set of learning modules associated with a first difficulty level and further comprising:
responsive to a determination that the answer for the question is an incorrect answer, selecting a second set of learning modules associated with a second difficulty level that is a lower difficulty level than the first difficulty level to form additional educational content; and
displaying the additional educational content, by the projector, wherein the additional educational content comprises a second question that is less difficult than the first question.

10. A computer program product comprising:
a computer usable medium including computer usable program code for displaying interactive, educational content, said computer program product comprising:
computer usable program code for selecting a set of learning modules associated with a subject matter to form education content;
computer usable program code for displaying the educational content on a surface, by the projector, wherein the educational content comprises a question;
computer usable program code for receiving a user input providing an answer for the question; and
computer usable program code for responsive to a determination that the answer for the question is a correct answer, displaying a reward light show on the surface, by the projector.

11. The computer program product of claim 10 further comprising:
computer usable program code for retrieving a user profile for a user;
computer usable program code for selecting the set of learning modules from a plurality of learning modules using the user profile; and
computer usable program code for generating the educational content using the selected set of learning modules, wherein the educational content is customized for the user.

12. The computer program product of claim 10 further comprising:
computer usable program code for retrieving a user profile for a particular user;
computer usable program code for selecting a set of learning modules from a plurality of learning modules using the user profile; and
computer usable program code for generating the reward light show using the selected set of learning modules, wherein the reward light show is customized for the particular user.

13. The computer program product of claim 10 wherein the set of learning modules is a first set of learning modules associated with a first difficulty level and further comprising:
computer usable program code for selecting a second set of learning modules associated with a second difficulty level that is a higher difficulty level than the first difficulty level to form additional educational content; and
computer usable program code for displaying the additional educational content, by the projector, wherein the additional educational content comprises a second question that is more difficult than the first question.

14. The computer program product of claim 10 wherein the set of learning modules is a first set of learning modules associated with a first difficulty level and further comprising:
computer usable program code for selecting a second set of learning modules associated with a second difficulty level that is a lower difficulty level than the first difficulty level to form additional educational content in response to a determination that the answer for the question is an incorrect answer; and
computer usable program code for displaying the additional educational content, by the projector, wherein the additional educational content comprises a second question that is less difficult than the first question.

15. An apparatus for presenting interactive educational content, the apparatus comprising:
a projector, wherein the projector further comprises:
a light source;
a set of projector lenses;
a bus system;
a communications system coupled to the bus system;
a memory connected to the bus system, wherein the memory includes computer usable program code; and
a processing unit coupled to the bus system, wherein the processing unit executes the computer usable program code to select a set of learning modules associated with a subject matter to form education content; display the educational content on a surface, by the projector, wherein the educational content comprises a question; receive a user input providing an answer for the question; and display a reward light show on the surface, by the projector, in response to a determination that the answer for the question is a correct answer.

16. The apparatus of claim 15 wherein the projector further comprises:
a controller, wherein the controller retrieves a user profile and selects the set of learning modules from a plurality of learning modules using the user profile; and
a learning module assembly, wherein the learning module assembly generates the educational content for the user using the set of learning modules, and wherein the educational content is customized educational content generated for a user.

17. The apparatus of claim 15 further comprising:
a selection device, wherein the selection device indicates an answer selected by a user, and wherein the selection device is a wand-shaped device.

18. The apparatus of claim 15 further comprising:
a selection device, wherein the selection device indicates an answer selected by a user, and wherein the selection device is a gun-shaped device.

19. The apparatus of claim 15 further comprising:
a selection device, wherein the selection device emits a beam of light and wherein the projector further comprises:
a sensor, wherein the sensor detects the beam of light emitted by the selection device, and wherein the beam of light indicates the answer selected by a user.

20. The apparatus of claim 15 further comprising:
a selection device, wherein the selection device emits a signal and wherein the projector further comprises:
a receiver, wherein the receiver receives the signal, and wherein the signal indicates the answer selected by a user.
